(19) United States
(12) Patent Application Publication
(10) Pub. No.: US 2020/0060404 A1
(43) Pub. Date: Feb. 27, 2020

(54) Flexible Curling Iron

(71) Applicant: Wah Wong Electric Manufactory (Longchuan) Co., Ltd., Heyuan (CN)

(72) Inventor: Michael Lu, Heyuan (CN)

(21) Appl. No.: 16/516,251

(22) Filed: Jul. 18, 2019

Related U.S. Application Data
(63) Continuation of application No. PCT/CN2018/111221, filed on Oct. 22, 2018.

(30) Foreign Application Priority Data
Aug. 27, 2018 (CN) 201821381467.5

(51) Int. Cl. A45D 1/04; H01R 4/60

(52) U.S. Cl. CPC A45D 1/04; H01R 4/60

(57) ABSTRACT

This invention relates to the field of household appliances, overcoming the drawback that the existing curling irons cannot curl multiple different curling styles. Disclosed is a flexible curling iron comprising a heating body and a control circuit connected with the heating body. The heating body comprises a wire for bending support, a first flexible insulating layer sleeved on the wire, a flexible heating layer wrapping the first flexible insulating layer, a second flexible insulating layer wrapping the flexible heating layer, and a flexible soft rubber layer wrapping the second flexible insulating layer, the flexible heating layer is electrically connected to the control circuit. The heating body mentioned in the invention can be bent at will, so that users can curl different type of curls at the same time according to their own preferences.

### CROSS REFERENCE TO RELATED APPLICATIONS

The present application is a Continuation Application of PCT Application No. PCT/CN2018/111221 filed on Oct. 22, 2018, which claims the benefit of Chinese Patent Application No. 201821381467.5 filed on Aug. 27, 2018. All the above are hereby incorporated by reference.

### TECHNICAL FIELD

This invention relates to the field of household appliances, in particular to a flexible hair curling iron.

### BACKGROUND OF THE INVENTION

The existing curling irons are typically straight. When curling, the hair is wrapped around the curling iron. The hair curls of a curling iron are almost the same, and it is not possible to change hair curls as desired.

### SUMMARY OF THE INVENTION

The purpose of this invention is to overcome the inability of existing curling irons to curl multiple different styles.

The technical solution adopted to solve the technical problem described in this invention is a flexible curling iron comprising a heating body and a control circuit connected with the heating body. The heating body is composed of a wire for bending support, a first flexible insulating layer sleeved on the wire, a flexible heating layer wrapping the first flexible insulating layer, a second flexible insulating layer wrapping the flexible heating layer, and a flexible soft rubber layer wrapping the second flexible insulating layer, the flexible heating layer is electrically connected to the control circuit.

The technical solution further defined by this invention includes: one end of the flexible heating layer is electrically connected to the control circuit through the first electrode, and the other end of the flexible heating layer is electrically connected to the control circuit through the connecting wire.

The flexible heating layer is electrically connected to the wire through a first connector, the first connector is provided with a first elastic metal tube electrically connected to the flexible heating layer, and a second elastic metal tube electrically connected to the wire, the first elastic metal tube and the second elastic metal tube are each provided with an elastic notch, and the first connector is located in the third soft tube.

The flexible heating layer is electrically connected to the first electrode through a second connector, the second connector is provided with a third elastic metal tube electrically connected to the flexible heating layer, and a fourth elastic metal tube electrically connected with the first electrode. Both the third and fourth elastic metal tube are provided with an elastic notch, and the second connector is located on the first flexible insulating layer and is located in the second flexible insulating layer.

The ends of the wire extend from both ends of the second flexible insulating layer and are fixedly mounted with the flexible soft rubber layer.

The metal wire is provided with a hook, and the flexible soft rubber layer is provided with a hanging ring matched with the hook.

The flexible soft rubber layer has an end cover on each end, and the control circuit is installed in one of the end covers, and the control circuit is provided with a power supply socket, and the end cover corresponding to the power supply socket is provided with a plug hole.

Through the above technical solution, the beneficial effect of the invention is that the heating body of the invention can be bent at will, and the user can curl different style of curls according to his own preference.

### BRIEF DESCRIPTION OF THE DRAWINGS

FIG. 1 is a schematic view showing an exploded structure of a flexible curling iron of this invention.

FIG. 2 is a schematic cross-sectional view showing the assembly of a flexible curling iron of this invention.

FIG. 3 is a structural schematic view showing the use state of a flexible curling iron of this invention.

### DETAILED DESCRIPTIONS

The structure of this invention will be further described below with reference to the accompanying figures.

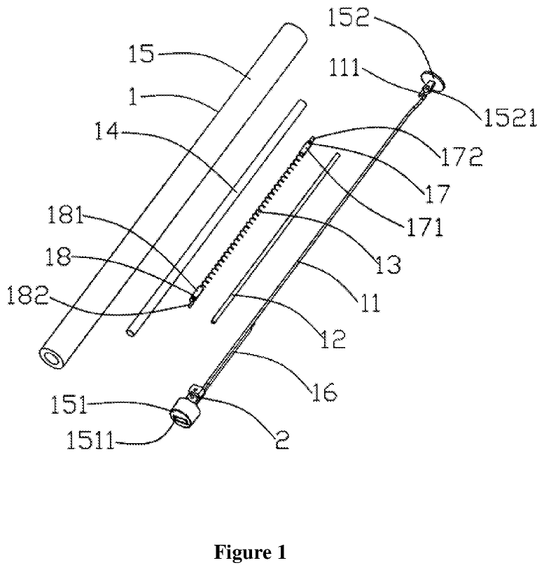

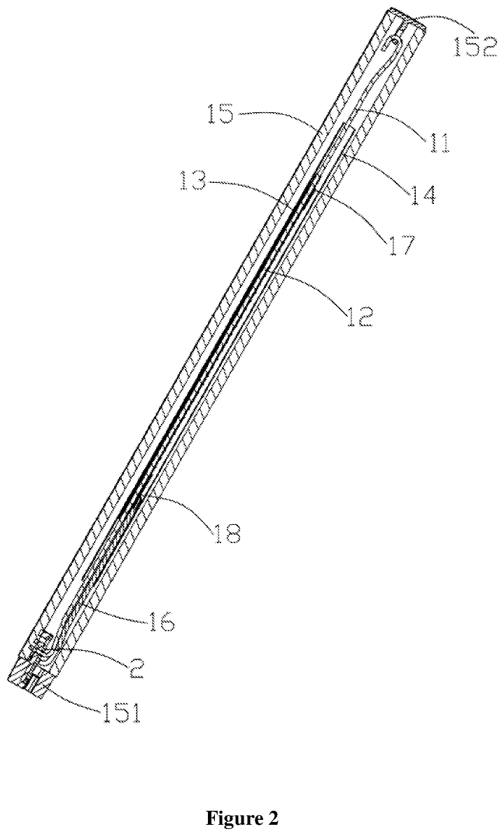

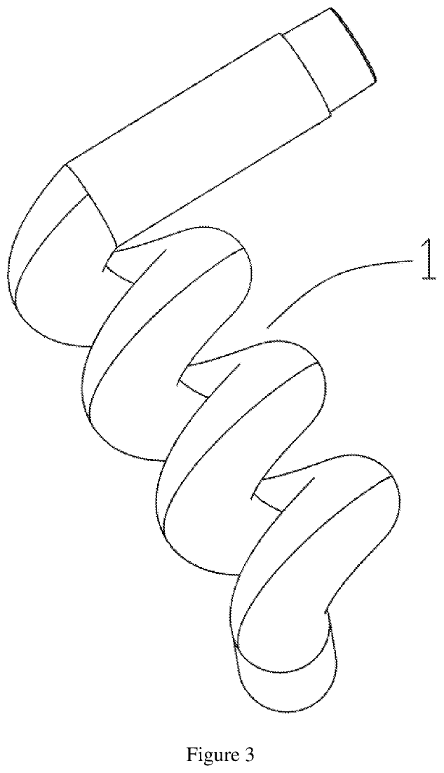

Referring to FIGS. 1 to 3, a flexible curling iron includes a heating body 1 and a control circuit 2 electrically connected to the heating body. The heating body 1 includes a wire 11 for bending support, a first flexible insulating layer 12 which is sleeved on the wire, a flexible heating layer 13 wrapped around the first flexible insulating layer, a second flexible insulating layer 14 sleeved on the flexible heating layer, and a flexible soft rubber layer 15 sleeved on the second flexible insulating layer, the flexible heating layer 13 electrically connected to the control circuit 2, and both ends of the wire 11 extend from the two ends of the second flexible insulating layer and are fixedly mounted with the flexible soft rubber layer.

In this implementation, one end of the flexible heating layer 13 is electrically connected to the control circuit 2 through the first electrode 16, and the other end of the flexible heating layer 13 is electrically connected to the control circuit through the connecting wire. The flexible heating layer 13 is electrically connected to the wire through the first connector 17, and the first connector 17 is provided with a first elastic metal tube 171 electrically connected to the flexible heating layer, and a second elastic metal tube 172 electrically connected to the metal wire. The first elastic metal tube and the second elastic metal tube are each provided with an elastic notch, and the first connector is located in the third soft tube. The first elastic metal tube and the second elastic metal tube are both elastic tubes, so that the first elastic metal tube is closely connected with the flexible heating layer, and the second elastic metal tube is tightly connected with the metal wire to prevent the heating layer and the wire from power supply interruption when bending. In this implementation, the flexible heating layer 13 is electrically connected to the first electrode 16 through the second connector 18, and the second connector 18 is provided with a third elastic metal tube 181 electrically connected to the flexible heating layer and the fourth elastic metal tube 182 connected to the first electrode. The third elastic metal tube and the fourth elastic metal tube are both provided with elastic notches, and the second connector is located on the first flexible insulating layer and is located in the second flexible insulating layer. The third elastic metal tube and the fourth elastic metal tube are both elastic tubes, so that the heating wire is tightly connected with the third elastic metal tube, and the fourth elastic metal tube is tightly connected with the first electrode to prevent the heating layer from being disconnected from the first electrode and cause power supply interruption when bending.

In this implementation, the two ends of the flexible soft rubber layer 15 are provided with end covers, which are respectively a first end cover 151 and a second end cover 152. The control circuit is installed in the first end cover 151, and the power supply socket is installed on the control circuit. The first end cover 151 is provided with a plug-in hole 1511 corresponding to the power supply socket. In this implementation, the wire 11 is provided with a hook 111, and the second end cover 152 is provided with a hanging ring 1521 that cooperates with the hook. When in use, power is supplied through the power socket, and the heating body of this invention can be bent at will, and the user can curl different styles at the same time according to his own preference.

Although the specific implementation of this invention is described in detail in conjunction with the figures, it should not be understood as a limit on the scope of protection of this invention. Within the scope described in the claim, various modifications and deformations that technical personnel in the field can make without creative labor are still within the scope of protection of this invention.

What is claimed is:

1. A flexible curling iron, comprising a heating body and a control circuit connected with the heating body, wherein the heating body comprises a wire for bending support, a first flexible insulating layer sleeved on the wire, a flexible heating layer wrapping the first flexible insulating layer, a second flexible insulating layer outside the flexible heating layer, and a flexible soft rubber layer outside the second flexible insulating layer, the flexible heating layer is electrically connected to the control circuit.

2. The flexible curling iron as described in claim 1, wherein one end of the flexible heating layer is electrically connected to the control circuit through the first electrode, and the other end of the flexible heating layer is connected with the control circuit through connecting wire.

3. The flexible curling iron as described in claim 2, wherein the flexible heating layer is electrically connected to the wire through the first connector, the first connector has a first elastic metal tube electrically connected with the flexible heating layer, and a second elastic metal tube electrically connected to the metal wire, wherein the first elastic metal tube and the second elastic metal tube are provided with elastic notches, and the first connector is located inside the third soft tube.

4. The flexible curling iron as described in claim 2, wherein the flexible heating layer is electrically connected to the first electrode through a second connector, the second connector has a third elastic metal tube electrically connected with the flexible heating layer, and a fourth elastic metal tube electrically connected to the first electrode, wherein both the third elastic metal tube and the fourth elastic metal tube are provided with elastic notches, and the second connector is located on the first flexible insulating layer and in the second flexible insulating layer.

5. The flexible curling iron as described in claim 1, wherein both ends of the wire extend from both ends of the second flexible insulating layer and are fixedly mounted with the flexible soft rubber layer.

6. The flexible curling iron as described in claim 5, wherein the wire is provided with a hook, and the flexible soft rubber layer is provided with a hanging ring matched with the hook.

7. The flexible curling iron as described in claim 1, wherein the flexible soft rubber layer is provided with covers at both ends, and the control circuit is installed in one of the covers. The control circuit is provided with a power supply socket, and the end cover corresponding to the power supply socket is provided with a plug-in hole.
